(19) United States
(12) Patent Application Publication
(10) Pub. No.: US 2021/0311500 A1
(43) Pub. Date: Oct. 7, 2021

(54) TRANSPORTATION SYSTEM, OPERATION MANAGEMENT DEVICE, AND OPERATION MANAGEMENT METHOD

(71) Applicants: TOYOTA JIDOSHA KABUSHIKI KAISHA, Toyota-shi (JP); DENSO CORPORATION, Kariya-city (JP)

(72) Inventors: Kenji OKAZAKI, Toyota-shi (JP); Hiroshi HIGASHIDE, Toyota-shi (JP); Keiichi UNO, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 17/216,186

(22) Filed: Mar. 29, 2021

(30) Foreign Application Priority Data
Apr. 2, 2020 (JP) 2020-066591

(51) Int. Cl. G05D 1/02

(52) U.S. Cl. CPC G05D 1/0297; G05D 1/0217; G05D 1/0221; G05D 1/0223

(57) ABSTRACT

A transportation system comprises a traveling route along which a plurality of stations are located; a plurality of vehicles that autonomously travel along the traveling route; and an operation management device, wherein the operation management device comprises a plan generation unit for generating a travel plan for each of the plurality of vehicles, and a communication apparatus which transmits the travel plan to the vehicles and receives user information from the vehicles and the stations; and the plan generation unit has at least two elimination policies for eliminating an operation interval error, and if the vehicles are delayed from the travel plan, selects one elimination policy from the at least two elimination policies based on at least the user information, and generates the travel plan according to the selected elimination policy.

### CROSS REFERENCE TO RELATED APPLICATION

This application claims priority to Japanese Patent Application No. 2020-066591 filed on Apr. 2, 2020, which is incorporated herein by reference in its entirety including the specification, claims, drawings, and abstract.

### TECHNICAL FIELD

The present disclosure relates to a transportation system including a plurality of vehicles that autonomously travel along a prescribed traveling route, an operation management device that manages the operation of the plurality of vehicles, and an operation management method.

### BACKGROUND

There has been known an operation management device that manages the operation of a plurality of vehicles. For example, JP 2005-222144 A discloses an operation information center that manages the operation of a plurality of buses. In JP 2005-222144 A, the plurality of the buses respectively transmit to the operation information center operation information including location information and a boarding rate of the buses. The operation information center determines whether or not the operation of each bus must be changed in accordance with the operation information in order to average the congestion degrees of the buses and to optimize the operation interval. The operation change includes a passage through a scheduled bus stop and a speed change. According to JP 2005-222144 A, for example, if one bus is crowded and a consecutive bus is about to catch up, the preceding crowded bus is made to pass the next scheduled bus stop, and the consecutive bus is made to take up passengers waiting at that bus stop. Thus, the congestion degrees are averaged and the operation interval is optimized.

In such a case, if the vehicle is delayed from a scheduled travel plan, the congestion degree of the vehicle is worsened easily. Specifically, when a certain vehicle is delayed from the scheduled travel plan and the distance between vehicles is locally increased, passengers tend to rush to the delayed vehicle, and the vehicle easily becomes crowded. It is normally required that if the delay occurs, the interval between the vehicles is adjusted to suppress the congestion in the vehicles from worsening.

According to the technology of JP 2005-222144 A, however, measures for congestion reduction or optimization of the operation interval are implemented only after the vehicle is overcrowded. Therefore, according to the technology of JP 2005-222144 A, the boarding rate of the vehicle becomes considerably high, although temporarily, and the convenience of the transportation system is easily impaired.

Under the above circumstances, the present disclosure relates to a transportation system, an operation management device, and an operation management method that can further improve the convenience of the transportation system.

### SUMMARY

The transportation system described in the present specification comprises a traveling route along which a plurality of stations are located; a line of vehicles consisting of a plurality of vehicles that autonomously travel along the traveling route; and an operation management device for managing the operation of the plurality of vehicles, wherein the operation management device includes a plan generation unit for generating a travel plan for each of the plurality of vehicles and a communication apparatus which transmits the travel plan to the vehicles and receives user information, which is information about the transportation system users, from at least either the vehicles or the stations; and the plan generation unit has at least two elimination policies for eliminating an interval error which is a difference between an operation interval of the vehicles and a predetermined target operation interval, and if the vehicles are delayed from the travel plan, selects one elimination policy from the at least two elimination policies on the basis of at least the user information, and generates the travel plan according to the selected elimination policy.

When configured as described above, overcrowding can be prevented because an interval error is remedied at the time when the delay occurs. And, since the elimination policy is selected based on the user information, the optimum elimination policy is selected depending on the situation, and the interval error can be eliminated effectively while suppressing the prolongation of unnecessary traveling and waiting times. As a result, convenience of the transportation system can be further improved.

In this case, the plan generation unit estimates, based on the user information, a time required for getting on/off the vehicles at the stations as an estimated getting-on/off time and may select the elimination policy based on at least the estimated getting-on/off time.

When the getting-on/off time is estimated and the elimination policy is selected based on the estimated getting-on/off time, it can be judged more surely whether the delayed vehicle can be accelerated, and a more appropriate elimination policy can be selected as a result.

In this case, the plan generation unit, when the estimated getting-on/off time is not greater than the prescribed standard getting-on/off time, selects a first elimination policy that eliminates the interval error without lowering the schedule speed of all the vehicles from the schedule speed before the delay occurs, and when the estimated getting-on/off time exceeds the standard getting-on/off time, selects a second elimination policy that eliminates the interval error by lowering the schedule speed of some vehicles from the schedule speed before the delay occurs.

According to the first elimination policy, none of the vehicles decelerate, so that prolongation of a waiting time at the stations and a traveling time of the users can be effectively suppressed. According to the second elimination policy, the interval error can be eliminated more surely even when it is hard to substantially accelerate the delayed vehicle.

Each of the vehicles has an in-vehicle sensor for obtaining occupant information from which at least the number of the occupants can be grasped, and transmits the occupant information to the operation management device, and the user information may include the occupant information.

The provision of the in-vehicle sensor enables more appropriate acquisition of the occupant information and improved estimation accuracy of the getting-on/off time.

Each of the stations has an in-station sensor for obtaining waiting person information from which at least the number of the waiting persons can be grasped, and transmits the waiting person information to the operation management device, and the user information may include the waiting person information.

The provision of the in-station sensor enables more appropriate acquisition of the waiting person information and improved estimation accuracy of the estimated getting-on/off time.

The user information may also be information from which attributes of users such as occupants or waiting persons can be grasped. The attributes may include at least one among the use of a wheelchair, the use of a white cane, the use of an orthosis, the use of a baby carriage, and age groups.

Inclusion of the user attributes into the user information can improve the estimation accuracy of the estimated getting-on/off time.

The operation management device disclosed in the present specification comprises a plan generation unit for generating a travel plan for each of a plurality of vehicles that autonomously travel along a prescribed traveling route, and a communication apparatus which transmits the travel plan to the vehicles and receives user information, which is information about users of the plurality of vehicles, from at least either the vehicles or the stations provided along the traveling route, wherein the plan generation unit has at least two elimination policies for eliminating an interval error which is a difference between an operation interval of the vehicles and a predetermined target operation interval, and if the vehicles are delayed from the travel plan, selects one elimination policy from the at least two elimination policies on the basis of at least the user information, and generates the travel plan according to the selected elimination policy.

The operation management method disclosed in the present specification comprises receiving user information, which is information about users of a plurality of vehicles, from at least either the plurality of vehicles that autonomously travel along a prescribed traveling route and stations disposed along the traveling route; and if the vehicles are delayed from a travel plan, selecting one elimination policy, on the basis of at least the user information, from at least two elimination policies for eliminating an interval error which is a difference between an operation interval of the vehicles and a predetermined target operation interval, and regenerating the travel plan according to the selected elimination policy; and transmitting the regenerated travel plan to the vehicles.

Convenience of the transportation system can be further improved by the technology disclosed in the present specification.

### BRIEF DESCRIPTION OF DRAWINGS

Embodiment(s) of the present disclosure will be described based on the following figures, wherein:

FIG. 1 is an image view of a transportation system;

FIG. 2 is a block diagram of the transportation system;

FIG. 3 is a block diagram showing a physical configuration of an operation management device;

FIG. 4 is a diagram showing an example of a travel plan used for the transportation system of FIG. 1;

FIG. 5 is an operation timing chart of respective vehicles autonomously traveling according to the travel plan of FIG. 4;

FIG. 6 is an image view showing a state that one vehicle is delayed;

FIG. 7 is an image view of a first elimination policy;

FIG. 8 is an operation timing chart of vehicles according to the first elimination policy;

FIG. 9 is an image view of a deceleration type second elimination policy;

FIG. 10 is a diagram showing an example of a travel plan which is regenerated according to the deceleration type second elimination policy;

FIG. 11 is an operation timing chart of vehicles according to the deceleration type second elimination policy;

FIG. 12 is an image view of a combination type second elimination policy;

FIG. 13 is a diagram showing an example of a travel plan which is regenerated according to the combination type second elimination policy;

FIG. 14 is an operation timing chart of vehicles according to the combination type second elimination policy; and

FIG. 15 is a flowchart showing a flow of the processing by a plan generation unit.

### DESCRIPTION OF EMBODIMENTS

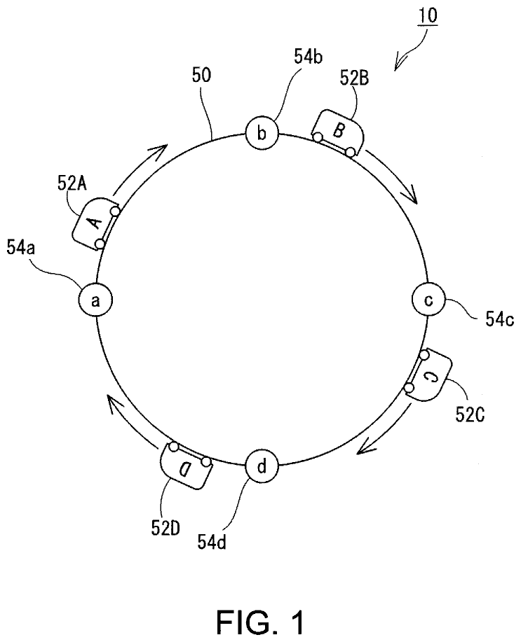

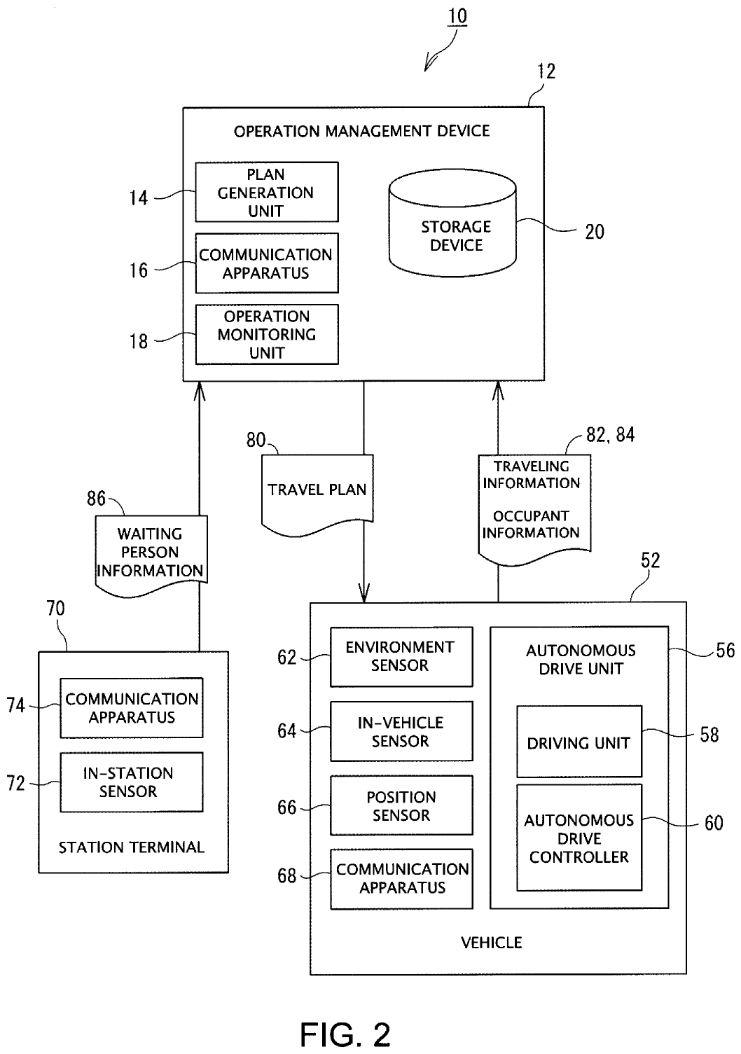

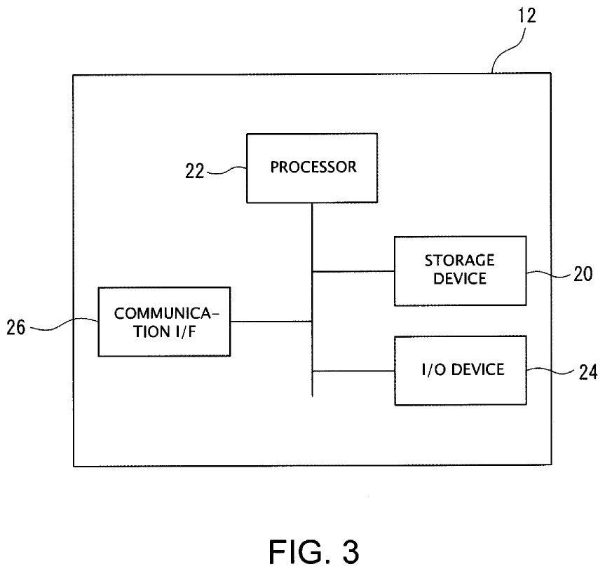

A configuration of a transportation system 10 is described with reference to the drawings. FIG. 1 is an image view of the transportation system 10, and FIG. 2 is a block diagram of the transportation system 10. FIG. 3 is a block diagram showing a physical configuration of an operation management device 12.

This transportation system 10 is a system for transporting many unspecified users along a predetermined traveling route 50. The transportation system 10 includes a plurality of stations 54a to 54d established along the traveling route 50, and a plurality of vehicles 52A to 52D autonomously travelable along the traveling route 50. In the following, when the plurality of vehicles 52A to 52D are not distinguished from one another, they are written as vehicles 52 with a subscript alphabet omitted. Similarly, when it is not required to distinguish the plurality of stations 54a to 54d from one another, they are written as stations 54.

The plurality of vehicles 52 form a line of vehicles by traveling circularly in one direction along the traveling route 50. The vehicles 52 stop temporarily at the respective stations 54. Users get on or get off the vehicles 52 when the vehicles 52 stop temporarily. Therefore, in the present case the respective vehicles 52 function as omnibuses for transporting many unspecified users from one station 54 to another. The operation management device 12 (not shown in FIG. 1; see FIG. 2 and FIG. 3) manages the operation of the plurality of vehicles 52. In the present case, the operation management device 12 controls the plurality of vehicles 52 to operate them at equal intervals. The equal-interval operation is an operation type to equalize the departure intervals of the vehicles 52 at the respective stations 54. Therefore, the equal-interval operation is an operation type such that when, for example, the departure interval at the station 54a is five minutes, the departure intervals at the other stations 54b, 54c, 54d also become five minutes.

Respective components configuring the transportation system 10 are described more specifically. The vehicles 52 autonomously travel according to a travel plan 80 provided by the operation management device 12. The travel plan 80 determines traveling schedules of the vehicles 52. In this case, the travel plan 80 specifies a departure timing of the vehicles 52 at the respective stations 54a to 54d. Details will be described later. The vehicles 52 travel autonomously so to depart according to the departure timing specified in the travel plan 80. In other words, the vehicles 52 make all the judgments about a travel speed between the stations, a stop at a red light or the like, necessity of passing another vehicle, and the like.

As shown in FIG. 2, the vehicle 52 has an autonomous drive unit 56. The autonomous drive unit 56 is roughly classified into a driving unit 58 and an autonomous drive controller 60. The driving unit 58 is a basic unit for causing the vehicle 52 to travel and includes, for example, a motor, a power transmission device, a brake device, a traveling device, a suspension device, a steering device, etc. The autonomous drive controller 60 controls the drive of the driving unit 58 to autonomously drive the vehicle 52. The autonomous drive controller 60 is a computer having, for example, a processor and a memory. The computer also includes a microcontroller having a computer system incorporated into a single integrated circuit. In addition, the processor means a processor in a broad sense (such as CPU: Central Processing Unit) and includes a general-purpose processor and a dedicated processor (such as GPU: Graphics Processing Unit, ASIC: Application Specific Integrated Circuit, FPGA: Field Programmable Gate Array, and a programmable logical device).

To enable autonomous traveling, the vehicle 52 is further mounted with an environment sensor 62 and a position sensor 66. The environment sensor 62 detects a peripheral environment of the vehicle 52, and includes, for example, a camera, Lidar, a millimeter wave radar, a sonar, a magnetic sensor, and the like. Based on the detection result by the environment sensor 62, the autonomous drive controller 60 recognizes the types of objects around the vehicle 52, distances from the objects, road surface markings (such as white lines) on the traveling route 50, traffic signs, and the like. The position sensor 66 which detects a current position of the vehicle 52 is, for example, a GPS receiver. The detection result by the position sensor 66 is also transmitted to the autonomous drive controller 60. The autonomous drive controller 60 controls acceleration/deceleration and steering of the vehicle 52 based on the detection results of the environment sensor 62 and the position sensor 66. The control status by the autonomous drive controller 60 is transmitted as traveling information 82 to the operation management device 12. The traveling information 82 includes the current position and the like of the vehicle 52.

The vehicle 52 is further provided with an in-vehicle sensor 64 and a communication apparatus 68. The in-vehicle sensor 64 is a sensor for obtaining occupant information 84 from which at least the number of the occupants can be easily obtained. The occupant information 84 may also be information from which the attributes of the occupants can also be grasped in addition to the number of the occupants. The attributes are characteristics that affect a getting-on/off time of the occupants. For example, the characteristics may include at least one among the use of a wheelchair, the use of a white cane, the use of a baby carriage, the use of an orthosis, and age groups. The in-vehicle sensor 64 is, for example, a camera for taking pictures of the inside of the vehicle, a weight sensor for detecting the total weight of the occupants, and the like. Information detected by the in-vehicle sensor 64 is transmitted as the occupant information 84 to the operation management device 12.

The communication apparatus 68 is an apparatus which performs radio communication with the operation management device 12. The communication apparatus 68 can perform Internet communication through, for example, a wireless LAN such as WiFi (registered trademark) or mobile data communication that is serviced by a cellular phone company or the like. The communication apparatus 68 receives the travel plan 80 from the operation management device 12 and transmits the traveling information 82 and the occupant information 84 to the operation management device 12.

Each of the stations 54 is provided with a station terminal 70. The station terminal 70 includes a communication apparatus 74 and an in-station sensor 72. The in-station sensor 72 is a sensor for obtaining waiting person information 86 from which at least the number of persons waiting for the vehicle 52 at the station 54 can be grasped. The waiting person information 86 may also be information from which the attributes of the waiting persons can also be grasped in addition to the number of the waiting persons. The attributes are characteristics that affect the getting on/off times of the occupants. For example, the characteristics may include at least one among the use of a wheelchair, the use of a white cane, the use of a baby carriage, the use of an orthosis, and age groups. The in-station sensor 72 is, for example, a camera for taking pictures of the station 54, a weight sensor for detecting the total weight of the waiting persons, and the like. Information detected by the in-station sensor 72 is transmitted as the waiting person information 86 to the operation management device 12. The communication apparatus 74 is provided for enabling transmission of the waiting person information 86.

The operation management device 12 monitors an operating state of the vehicle 52 and controls the operation of the vehicle 52 depending to the operation state. The operation management device 12 is a computer physically including a processor 22, a storage device 20, an I/O device 24, and a communication I/F 26 as shown in FIG. 3. This processor is a processor in a broad sense which includes a general-purpose processor (e.g., a CPU) and a dedicated processor (e.g., a GPU, ASIC, FPGA, programable logical device, etc.). The storage device 20 may include at least one of semiconductor memories (such as RAM, ROM, a solid-state device, and the like) and magnetic disks (such as a hard disk drive and the like). FIG. 3 shows the operation management device 12 as a single computer, but it may be configured of a plurality of physically separated computers.

The operation management device 12 functionally includes a plan generation unit 14, a communication apparatus 16, an operation monitoring unit 18, and the storage device 20 as shown in FIG. 2. The plan generation unit 14 generates the travel plan 80 for each of the plurality of vehicles 52. The travel plan 80 is generated so that the operation interval of the plurality of vehicles 52 becomes a predetermined target operation interval.

In this case, when the vehicle 52 is delayed from the travel plan 80, the actual operation interval of the vehicle 52 is deviated from the target operation interval. In the following description, this deviation from the target operation interval is called interval error. In this case, the plan generation unit 14 has at least two types of elimination policies for eliminating the interval error by adjusting the operation interval. And, when the vehicle 52 is delayed not less than a prescribed level from the travel plan 80, the plan generation unit 14 regenerates the travel plan 80 in accordance with an alternatively selected elimination policy. This will be described later.

The communication apparatus 16 is an apparatus for wireless communication with the vehicle 52 and can conduct internet communication using, for example, WiFi or mobile data communication. The communication apparatus 16 transmits the travel plan 80 generated or regenerated by the plan generation unit 14 to the vehicle 52 and receives the traveling information 82 and the occupant information 84 from the vehicle 52 and the waiting person information 86 from the station terminal 70. In the following, the occupant information 84 and the waiting person information 86 are collectively called user information.

The operation monitoring unit 18 obtains the operating states of the vehicles 52 based on the traveling information 82 transmitted from the respective vehicles 52. As described above, the traveling information 82 includes the present locations of the vehicles 52. The operation monitoring unit 18 compares the locations of the respective vehicles 52 with the travel plan 80 and calculates a delay amount DL of each of the vehicles 52 from the travel plan 80. The delay amount DL may be a difference in distance between the target location and the actual location of the vehicle 52 or may be a difference in time between a target time to reach a specified point and an actual arrival time. The delay amount DL may be acquired at a prescribed time interval (e.g., one-minute interval) or timing when a particular event has occurred. In this case, the event may be, for example, a departure of the vehicle 52 from a particular station 54. The operation monitoring unit 18 also calculates the operation intervals of the plurality of vehicles 52 based on the locations of the respective vehicles 52. The operation intervals calculated here may be a time interval or a distance interval.

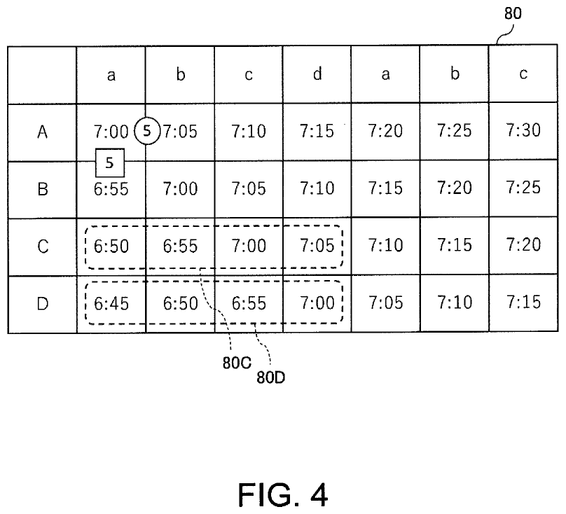

Generation of the travel plan 80 by the operation management device 12 will be described below in detail. FIG. 4 is a diagram showing an example of the travel plan 80 used by the transportation system 10 of FIG. 1. In the example of FIG. 1, the line of vehicles is composed of the four vehicles 52A to 52D, and the four stations 54a to 54d are arranged at equal distance intervals along the traveling route 50. In the present case, it is determined that the time required for the respective vehicles 52 to go around the traveling route 50 once; namely, a circulating time TC, is twenty minutes.

In this case, the operation management device 12 generates the travel plan 80 in which a departure interval of the vehicle 52 at the respective stations 54 becomes a time 20/4=5 minutes calculated by dividing the circulating time TC by number N of the vehicles 52. As shown in FIG. 4, only departure timings at the respective stations 54 are recorded in the travel plan 80. For example, target times when the vehicle 52D leaves the stations 54a to 54d respectively are recorded in the travel plan 80D which is transmitted to the vehicle 52D.

Only a time schedule for one round is generally recorded in the travel plan 80, and it is transmitted from the operation management device 12 to the vehicles 52 at timing when the respective vehicles 52 have reached a particular station, such as the station 54a. For example, the vehicle 52C receives from the operation management device 12 the travel plan 80C for one round when it arrives at the station 54a (e.g., at 6:49), and the vehicle 52D receives from the operation management device 12 the travel plan 80D for one round when it arrives at the station 54a (e.g., at 6:44). However, when the travel plan 80 is modified due to a delay or the like of the vehicle 52, a new travel plan 80 is transmitted from the operation management device 12 to the vehicle 52 even when the vehicle 52 has not arrived at the station 54a. When the new travel plan 80 is received, the respective vehicles 52 discard the old travel plan 80 before that and travel autonomously according to the new travel plan 80.

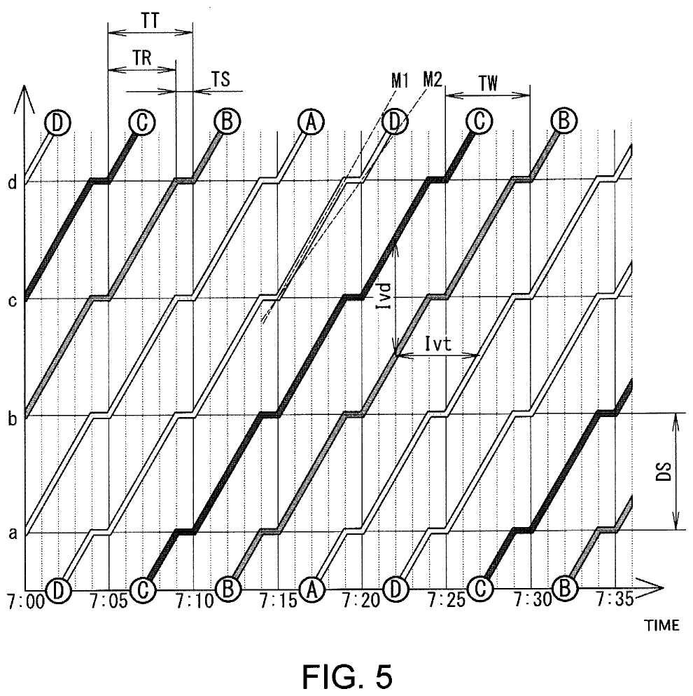

The respective vehicles 52 autonomously travel according to the received travel plan 80. FIG. 5 is an operation timing chart of the respective vehicles 52A to 52D which autonomously travel according to the travel plan 80 of FIG. 4. In FIG. 5, the horizontal axis indicates the time, and the vertical axis indicates the locations of the vehicles 52. The traveling states of the respective vehicles 52 are described below. In advance, various kinds of parameters used in the following description are explained briefly.

In the following description, a distance from one station 54 to a next station 54 is called station-to-station distance DS. A time duration between the departure of the vehicle 52 from one station 54 and the departure from the next station 54 is called required station-to-station time TT and a time duration when the vehicle 52 stops at a station 54 for users to get on/off is called stop time TS. In addition, a time duration in which the vehicle 52 leaves one station 54 and arrives the next station 54; namely, a time calculated by subtracting the stop time TS from the required station-to-station time TT, is called station-to-station traveling time TR. In FIG. 4, the number in the circle shows the required station-to-station time TT.

In addition, a value which is calculated by dividing a traveled distance by a traveling time including the stop time TS is called schedule speed VS and a value which is calculated by dividing the traveled distance by the traveling time not including the stop time TS is called average travel speed VA. The slope of line M1 in FIG. 5 shows the average travel speed VA, and the slope of line M2 in FIG. 5 shows the schedule speed VS. The schedule speed VS is inversely proportional to the required station-to-station time TT.

As described above, the operation interval calculated by the operation monitoring unit 18 may be a time interval or a distance interval. The time interval is a time interval in which two vehicles 52 pass through the same location. It is, for example, an interval Ivt in FIG. 5. The distance interval is a distance interval of two vehicles 52 at the same time, and is, for example, an interval Ivd in FIG. 5. The number enclosed by the square frame in FIG. 4 denotes a temporal operation interval.

Next, the operation of vehicles 52 will be described with reference to FIG. 5. According to the travel plan 80 of FIG. 4, the vehicle 52A leaves the station 54a at 7:00 and five minutes later, it must leave the station 54b at 7:05. The vehicle 52A controls its average travel speed VA so that the travel from the station 54a to the station 54b and getting-on/off of the users are completed in the above period of five minutes.

Specifically, the vehicle 52 stores previously a standard stop time TS necessary for getting-on/off of users as a scheduled stop time TSp. The vehicle 52 calculates, as a target arrival time at the station 54, the time resulting from subtraction of the scheduled stop time TSp from the departure time at the station 54 specified in the travel plan 80. For example, when the scheduled stop time TSp is one minute, the target arrival time of the vehicle 52A to the station 54b becomes 7:04. The vehicle 52 controls its travel speed so that it can arrive at the next station 54 by the above calculated target arrival time.

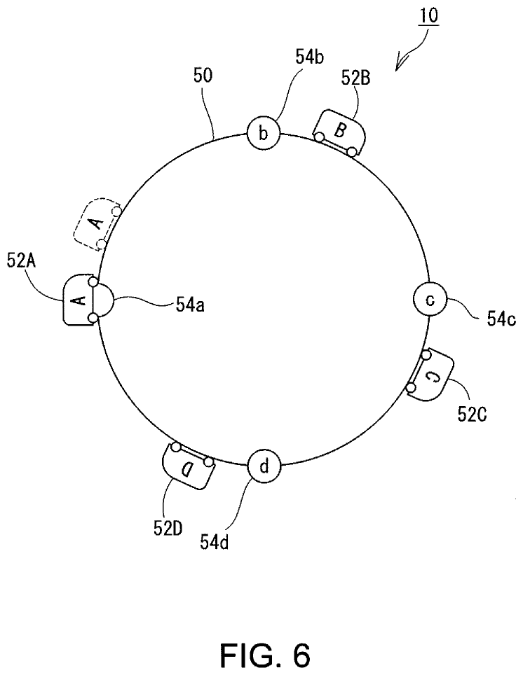

Incidentally, the vehicles 52 are sometimes partly or totally delayed from the travel plan 80 due to a congestion state of the traveling route 50, an increase of the number of the users, and the like. For example, a delay of the vehicle 52A is considered below. FIG. 6 is an image view showing that the one vehicle 52A is delayed. In FIG. 6, the vehicle indicated with a broken line shows an ideal location of the vehicle 52A. As is apparent from FIG. 6, when the one vehicle 52A is delayed, the operation interval between the delayed vehicle 52A and the preceding vehicle 52B is increased, and the operation interval between the delayed vehicle 52A and the following vehicle 52D is decreased. In other words, the above delay causes an interval error which is a difference between the actual operation interval and the target operation interval.

When the occurred delay is not less than a fixed level, the plan generation unit 14 attempts to adjust the operation interval to eliminate the interval error. As a method for adjustment of the operation interval, several types can be used. For example, in the case of FIG. 6, the interval error can be eliminated by temporarily accelerating the delayed vehicle 52A or by decelerating the vehicles 52B to 52D other than the delayed vehicle 52A.

A suitable adjusting method is variable depending on the operation states of the vehicles 52 and particularly the getting-on/off times of the users at the stations 54. Then, the plan generation unit 14 of this case prepares a plurality of types of elimination policies which determine how the interval error is eliminated, and when not less than a fixed level of delay occurs, selects one elimination policy according to the occupant information 84 and the waiting person information 86 (namely, user information). The plan generation unit 14 generates the travel plan 80 according to the selected elimination policy. Details will be described below.

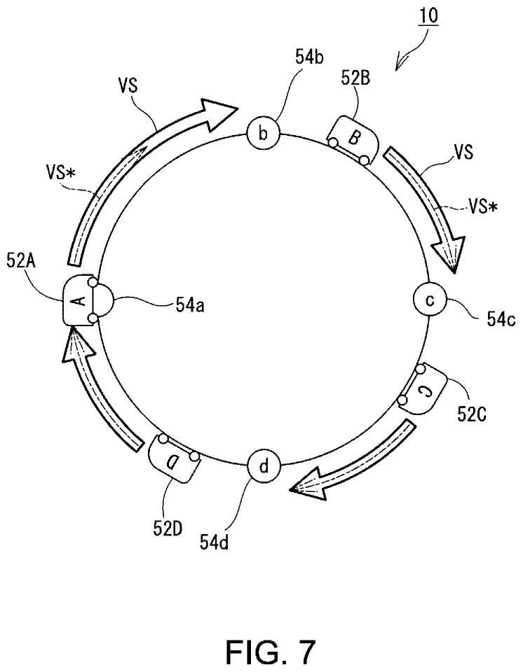

First, the elimination policies owned by the plan generation unit 14 will be described. The plan generation unit 14 of this case has a first elimination policy and a second elimination policy. The first elimination policy is a policy for adjusting the operation interval of all vehicles 52 in the travel plan 80 without decelerating them to a level lower than a schedule speed VS* before the occurrence of the delay. FIG. 7 is an image view of the first elimination policy. In FIG. 7, outlined arrows show the schedule speeds VS of the respective vehicles 52, and arrows indicated by dot-and-dash lines show the schedule speed VS* before the occurrence of the delay. Here, before the occurrence of the delay, the plurality of vehicles 52 are determined to travel at the same schedule speed VS* according to the travel plan 80. In the following, the schedule speed before the occurrence of the delay is called standard schedule speed VS*. In the case of FIG. 4, the standard schedule speed VS* is such a speed that the required station-to-station time TT becomes five minutes.

As shown in FIG. 7, it is assumed that the vehicle 52A is delayed from the travel plan 80 for some reason, the interval distance between the delayed vehicle 52A and the preceding vehicle 52B is increased, and the interval distance between the delayed vehicle 52A and the following vehicle 52D is decreased. According to the first elimination policy, none of the vehicles 52 is decelerated and the delayed vehicle 52A is temporarily accelerated to a level higher than the standard schedule speed VS* to eliminate the interval error. Thus, the operation interval of the respective vehicles 52 is adjusted to the predetermined target operation interval, and the equal-interval operation can be resumed.

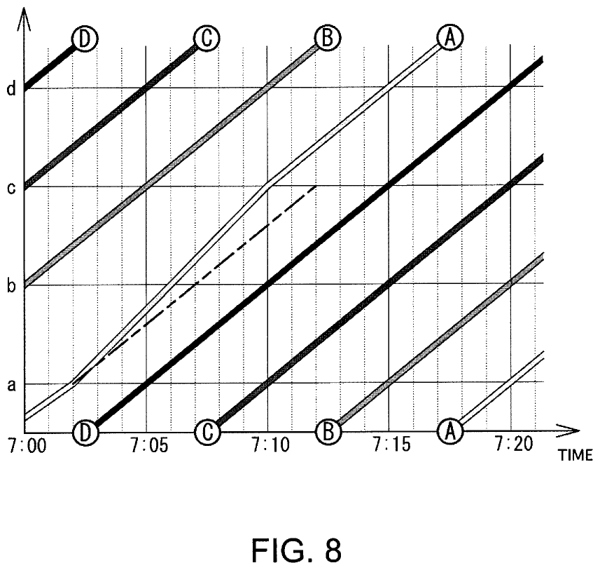

FIG. 8 is an operation timing chart of the vehicles 52 according to the first elimination policy. FIG. 8 shows the stop times TS of the respective vehicles 52 as zero to make it easy to grasp the schedule speeds VS of the respective vehicles 52. In this case, the slopes of the operation lines of the respective vehicles 52 show the schedule speeds VS. Meanwhile, the slope of the dot-and-dash line in FIG. 8 shows the standard schedule speed VS*.

In the case of FIG. 8, the vehicle 52A leaves the station 54a at 7:02, which is two minutes behind the travel plan 80. Consequently, the operation interval of the plurality of vehicles 52 becomes non-uniform. To eliminate the non-uniformity of the operation interval and consequently eliminate the interval error, the delayed vehicle 52A is temporarily accelerated to a level higher than the standard schedule speed VS* in the case of FIG. 8. As a result, when the delayed vehicle 52A leaves the station 54c at 7:10, the non-uniformity of the operation interval is eliminated, and the equal-interval operation can be resumed.

Here, the travel plan 80 may or may not be modified to temporarily accelerate the delayed vehicle 52A. That is, the travel plan 80 in which no delay has occurred specifies the departure timings of all the vehicles 52A to 52D so that they travel at the standard schedule speed VS* as shown in FIG. 4. If the vehicle 52A is delayed, the delayed vehicle 52A is accelerated so to be operated according to the travel plan 80 even if the travel plan 80 is not modified. For example, it is assumed that the vehicle 52A left the station 54a at 7:02 for some reason. In this case, when the travel plan 80 is not modified, the delayed vehicle 52A needs to leave the station 54b at 7:05, and the required station-to-station time TT becomes three minutes. Therefore, the delayed vehicle 52A needs to accelerate to a level higher than the standard schedule speed VS* (namely, a speed such that the required station-to-station time TT becomes five minutes). Therefore, even when the travel plan 80 is not modified, the delayed vehicle 52A attempts to meet the travel plan 80 by accelerating temporarily to a level higher than the standard schedule speed VS*.

Therefore, it is generally the case that when the first elimination policy is selected, the plan generation unit 14 does not generate the travel plan 80 dedicated for elimination of an interval error even when the delayed vehicle occurs, but generates the same travel plan 80 at the same timing with the case without delay. Exceptionally, when all the plurality of vehicles 52A to 52D are delayed, the plan generation unit 14 generates the travel plan 80 which is rescheduled based on the minimum delayed vehicle such that the delay amount DL becomes minimum so to drive all the vehicles 52A to 52D at the standard schedule speed VS*. For example, it is assumed that the vehicle 52A is delayed by two minutes and the vehicle 52B to the vehicle 52D are delayed by one minute. In this case, the plan generation unit 14 regenerates the travel plan 80 in which all the departure timings stored in it before modification are put off by one minute.

In any case, if the first elimination policy is followed, none of the vehicles 52 are decelerated, so that it is possible to effectively prevent an increase of the traveling time and waiting time of users of the respective vehicles 52.

In contrast, the first elimination policy requires that the delayed vehicle 52A can be accelerated to a level higher than the standard schedule speed VS*. However, the delayed vehicle 52A is sometimes hard to accelerate depending on the situations of users of the transportation system 10.

Specifically, to increase the schedule speed VS, it is necessary that the average travel speed VA is increased or that the stop time TS is decreased. However, unless the station-to-station distance DT is very long, it is hard to substantially decrease the traveling time even if the average travel speed VA is increased. Therefore, it is effective to decrease the stop time TS in order to increase the schedule speed VS. However, getting on/off at the station 54 takes time, depending on the situations of the waiting persons at the station 54 and the occupants in the vehicles, and it is sometimes hard to decrease the stop time TS and to increase the schedule speed VS.

If the delayed vehicle 52A cannot be accelerated, the interval error cannot be eliminated by the first elimination policy. Therefore, the plan generation unit 14 also has the second elimination policy in addition to the first elimination policy. The second elimination policy is a policy to eliminate the interval error by decelerating temporarily at least some of the vehicles 52 to a level lower than the standard schedule speed VS* given in the travel plan 80. The second elimination policy is further divided into a deceleration type elimination policy and a combination type elimination policy.

When the deceleration type elimination policy is selected, the plan generation unit 14 reschedules the travel plan 80 based on a maximum delayed vehicle that has a maximum delay amount AD, makes the maximum delayed vehicle travel at the standard schedule speed VS* in the travel plan 80, and makes the vehicles 52 other than the maximum delayed vehicle 52 decelerate temporarily from the standard schedule speed VS*.

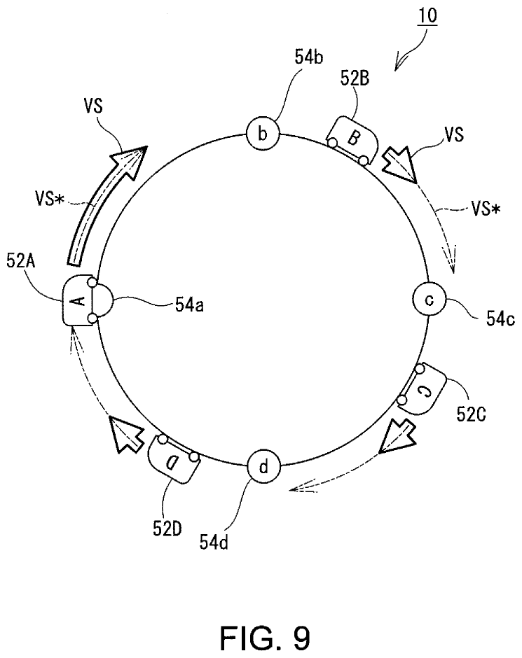

FIG. 9 is an image view of the deceleration type elimination policy. In FIG. 9, outlined arrows show the schedule speeds VS of the respective vehicles 52 and arrows indicated by the dot-and-dash line show the standard schedule speeds VS*. In FIG. 9, only the vehicle 52A is delayed, and the other vehicles 52B to 52D are not delayed. According to the deceleration type elimination policy, the vehicle 52A, which is a maximum delayed vehicle, is caused to travel at the standard schedule speed VS*, and the other vehicles 52B to 52D are temporarily decelerated to a level lower than the standard schedule speed VS*. Here, the schedule speed VS can be easily decelerated by increasing the stop time TS at the station 54. In other words, the interval error can be eliminated surely according to the deceleration type elimination policy, regardless of a road surface condition, a congestion state, the number of users, and the like.

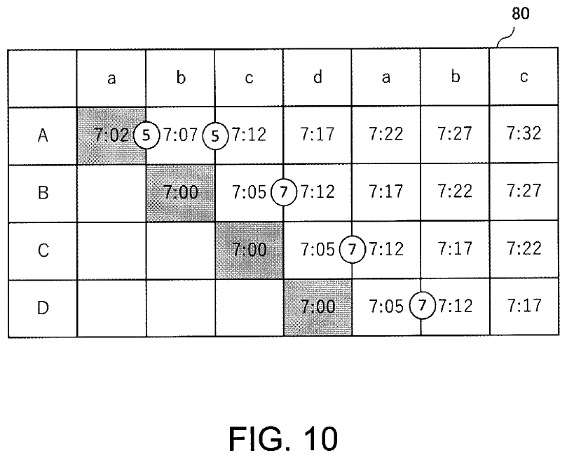

FIG. 10 is a diagram showing an example of the travel plan 80 regenerated according to the deceleration type elimination policy. It is assumed that the respective vehicles 52 were traveling according to the travel plan 80 of FIG. 4 and the vehicle 52A departed from the station 54a at 7:02, which was two minutes behind the schedule, for some reason. When it is detected that the vehicle 52A is delayed, the plan generation unit 14 reschedules the travel plan 80 for the vehicle 52A based on the present location of the vehicle 52A. In other words, the departure timings of the vehicle 52A from the station 54b, the station 54c, and the station 54d are changed to 7:07, 7:12, and 7:17, which are five minutes later, ten minutes later, and fifteen minutes later than 7:02.

The travel plan 80 for the other vehicles 52B to 52D is also changed in conjunction with the change of the travel plan 80 for the vehicle 52A. Specifically, in the case of FIG. 4, the vehicles 52B, 52C, 52D were respectively planned to leave the stations 54d, 54a, 54b at 7:10. But, when a delay is detected, the travel plan 80 is changed such that they leave at 7:12. As a result, the vehicles 52B to 52D temporarily have the required station-to-station time TT of seven minutes, and the schedule speed VS is lowered to a level lower than the standard schedule speed VS*.

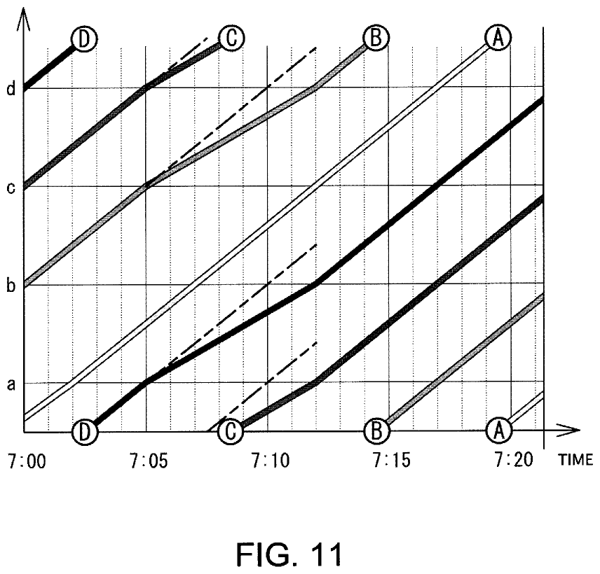

FIG. 11 is an operation timing chart of the vehicle 52 following the deceleration type elimination policy. In FIG. 11, the stop time TS of the respective vehicles 52 is zero, and the slope of the dot-and-dash lines shows the standard schedule speed VS*.

In the case of FIG. 11, the vehicle 52A leaves the station 54a at 7:02, which is two minutes behind the travel plan 80. To eliminate the interval error caused by the delay, the vehicles 52B to 52D other than the delayed vehicle 52A are temporarily decelerated from the standard schedule speed VS* in the case of FIG. 11. As a result, the non-uniformity of the operation interval is eliminated at 7:12, and the equal-interval operation can be resumed. Thus, when the deceleration type elimination policy is followed, the interval error can be eliminated surely even under a situation that the delayed vehicle 52 cannot be accelerated.

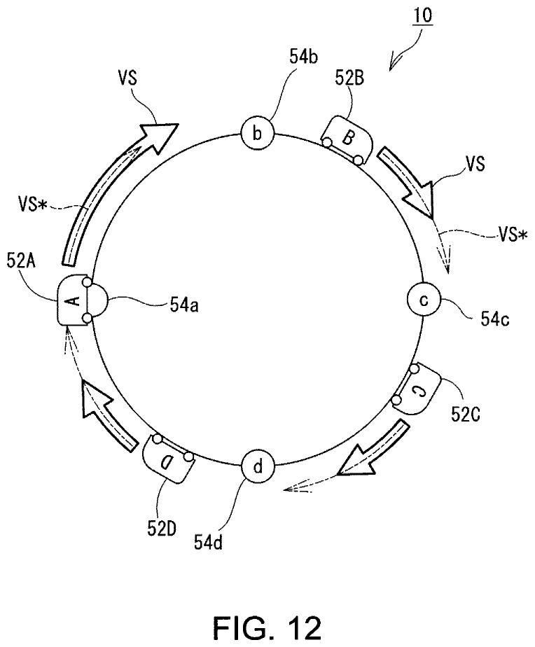

Next, the combination type elimination policy is described for reference. According to the combination type elimination policy, the travel plan 80 is rescheduled so that the delay amount DL of the respective vehicles 52 against the current travel plan 80 becomes uniform. FIG. 12 is an image view of the combination type elimination policy. In FIG. 12, outlined arrows show the schedule speeds VS of the respective vehicles 52 and arrows indicated by the dot-and-dash lines show the standard schedule speeds VS*.

According to the combination type elimination policy, all the vehicles 52A to 52D are delayed by a certain amount from the travel plan 80 which is before the occurrence of the delay. Here, a delay amount DL* to be given to all the vehicles 52A to 52D is calculated based on the delay amount DL of the plurality of vehicles 52. For example, the given delay amount DL* may be half of the delay amount DL of the maximum delayed vehicle 52A that has the delay amount DL in maximum. The given delay amount DL* may be an average value of the delay amount DL of the maximum delayed vehicle 52 and the delay amount DL of the minimum delayed vehicle 52 that has the delay amount DL in minimum (or no delay). Further, the given delay amount DL* may be an average value of the delay amounts DL of all the vehicles 52.

In any event, to make the delay amount DL uniform, the delay amount DL of the delayed vehicle 52A is decreased, and the delay amount DL of the other vehicles 52B to 52D is increased. In other words, according to the combination type elimination policy, some vehicles 52 are accelerated to a level higher than the standard schedule speed VS*, and other vehicles 52 are decelerated to a level lower than the standard schedule speed VS*.

Here, as is apparent from the comparison of FIG. 12 and FIG. 7, an acceleration amount of the delayed vehicle 52A is suppressed to a smaller level by the combination type elimination policy than by the first elimination policy. Therefore, the combination type elimination policy is easily adopted even if it is hard to substantially accelerate the delayed vehicle 52A. As is apparent from the comparison of FIG. 12 and FIG. 9, deceleration amounts of the other vehicles 52B to 52D can be suppressed to a smaller level according to the combination type elimination policy than according to the deceleration type elimination policy. Therefore, the combination type elimination policy can suppress an increase of traveling time and waiting time of the users of the other vehicles 52B to 52D to a low level.

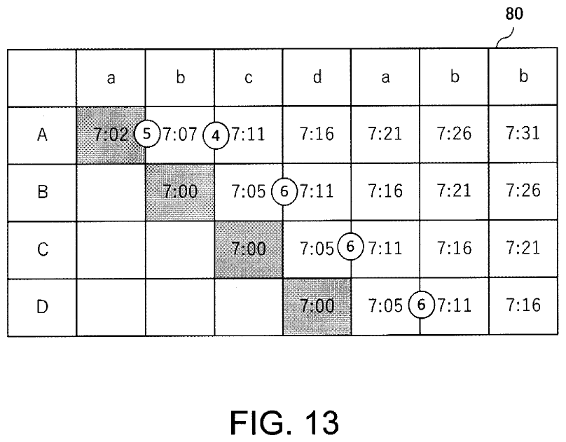

FIG. 13 is a diagram showing an example of the travel plan 80 regenerated according to the combination type elimination policy. It is assumed that the respective vehicles 52 were traveling according to the travel plan 80 of FIG. 4, but the vehicle 52A left the station 54a at 7:02, which is two minutes behind the travel plan 80, for some reason. If the delay of the vehicle 52A is detected, the plan generation unit 14 generates a new travel plan 80 so that the delay amount DL against the travel plan 80 of FIG. 4 becomes uniform among the plurality of vehicles 52A to 52D. In the case of FIG. 13, it is rescheduled so that all the vehicles 52A to 52D are one minute behind the travel plan 80 of FIG. 4 after the timing when the vehicle 52A leaves the station 54c (namely, after 7:11). In this case, the delayed vehicle 52A is temporarily accelerated just before 7:11 so that the required station-to-station time TT becomes four minutes. Meanwhile, the other vehicles 52B to 52D are temporarily decelerated so that the required station-to-station time TT becomes six minutes.

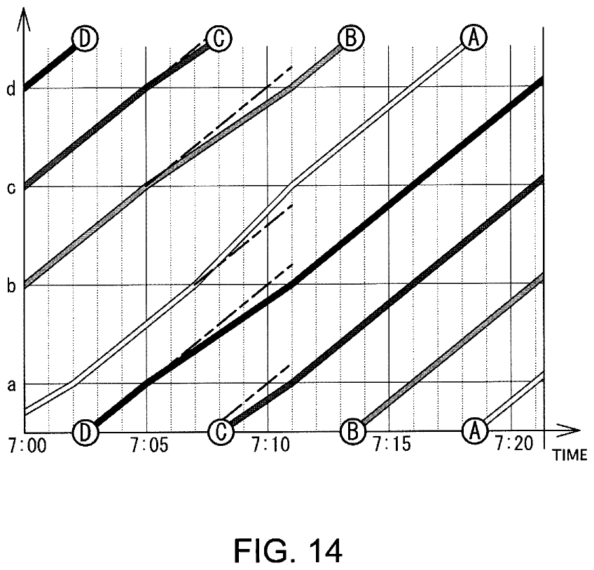

FIG. 14 is an operation timing chart of the vehicle 52 when following the combination type elimination policy. In FIG. 14, the stop time TS of the respective vehicles 52 is set to zero and the slopes of the dot-and-dash lines show the standard schedule speed VS*.

In the case of FIG. 14, the vehicle 52A leaves the station 54 at 7:02, which is two minutes behind the travel plan 80. To eliminate the interval error caused by the delay in the case of FIG. 14, the delayed vehicle 52A is temporarily accelerated to a level higher than the standard schedule speed VS*, and the other vehicles 52B to 52D are temporarily decelerated from the standard schedule speed VS*. As a result, the nonuniform operation interval is eliminated at 7:11, and the equal-interval operation can be resumed. Thus, by following the combination type elimination policy, the interval error can be eliminated while the speed change of the respective vehicles 52 is suppressed to a small level.

In this case, the elimination policy to be used for elimination of the interval error is selected according to the user information. The user information is used as a reference, because the user information considerably affects the getting-on/off time at the stations 54.

In other words, the user information includes the occupant information 84 and the waiting person information 86. Between them, the occupant information 84 is information showing the number and attributes of occupants who are on the vehicles 52. It is, for example, information obtained by analyzing the photographed images of the vehicle interior. The number and attributes of the occupants considerably affect the getting-off time at the station 54. For example, the getting-off time at the station 54 becomes longer and the stop time of the vehicle 52 becomes longer as the number of the occupants is larger. When an occupant uses a wheelchair, a white cane, an orthosis, or a baby carriage, the getting off time easily becomes longer than when the passenger does not use the above. In addition, an infant in a younger age group and an aged person in a higher age group are apt to take a longer time to get off than do people belonging to the age group between the above two age groups.

The waiting person information 86 is information transmitted from the station terminal 70 and shows the number and characteristics of persons in the waiting person information 86 waiting for the vehicles 52 at the stations. The waiting person information 86 may be transmitted periodically and a plurality of times from the station terminal 70 to the operation management device 12. By configuring in this way, the operation management device 12 can grasp a temporal change of the number and attributes of the waiting persons.

The plan generation unit 14 estimates the getting-on/off time at the station 54 as the estimated getting-on/off time according to the occupant information 84 and the waiting person information 86. This estimating method is not particularly limited, but, for example, the getting-off times of the respective occupants from one vehicle 52 are identified based on the attributes, and the integrated value may be calculated as the getting-off time of the whole vehicles 52. A value calculated by dividing the calculated getting-off time of the whole vehicles 52 by a ratio predefined for each station may be calculated as the getting-off time when the vehicle 52 arrives the station. For example, it is assumed that a ratio of the getting-off times at the plurality of stations 54a to 54d obtained from the past operation history is 1:1:2:1. When the total getting-off time of a single vehicle 52A is Ta, the getting-off time when the vehicle 52A arrives at the station 54a can be calculated as Ta×1/5.

The plan generation unit 14 may periodically estimate the getting-on time at a single station 54 based on the number and attributes of waiting persons at the station 54 and calculate an increase amount per unit time of the getting-on time. Then, based on the calculated increase amount, the plan generation unit 14 may calculate the getting-on time of the waiting persons at the timing when the vehicle 52 has arrived at the station 54. For example, it is assumed that an increase of the getting-on time per minute at the single station 54a is six seconds and the vehicles 52 leave the station at a five-minute interval. In this case, the plan generation unit 14 may presume that the getting-on time at the station as 6×5=30 seconds.

As is apparent from the above description, the estimated getting-on/off time TE of the maximum delayed vehicle 52 at the station 54 can be calculated for the number of the stations 54. Concerning the maximum delayed vehicle 52A in the case of FIG. 6, calculation can be performed for the estimated getting-on/off time TE at the station 54a, the estimated getting-on/off time TE at the station 54b, the estimated getting-on/off time TE at the station 54c, and the estimated getting-on/off time TE at the station 54d. For selection of the elimination policy, among the above plurality of estimated getting-on/off times TE, there may be used the getting-on/off time TE at the station 54 where the vehicle 52 arrives in the closest future, or a statistical value (e.g., a maximum value or an average value) of the plurality of estimated getting-on/off times TE.

In any case, if not less than a fixed amount of delay occurs, the plan generation unit 14 presumes the estimated getting-on/off time of the maximum delayed vehicle 52 at the station 54 based on at least one of the getting-off time presumed from the occupant information 84 and the getting-on time presumed from the waiting person information 86. The plan generation unit 14 selects the elimination policy based on the estimated getting-on/off time and generates the travel plan 80 based on the selected elimination policy.

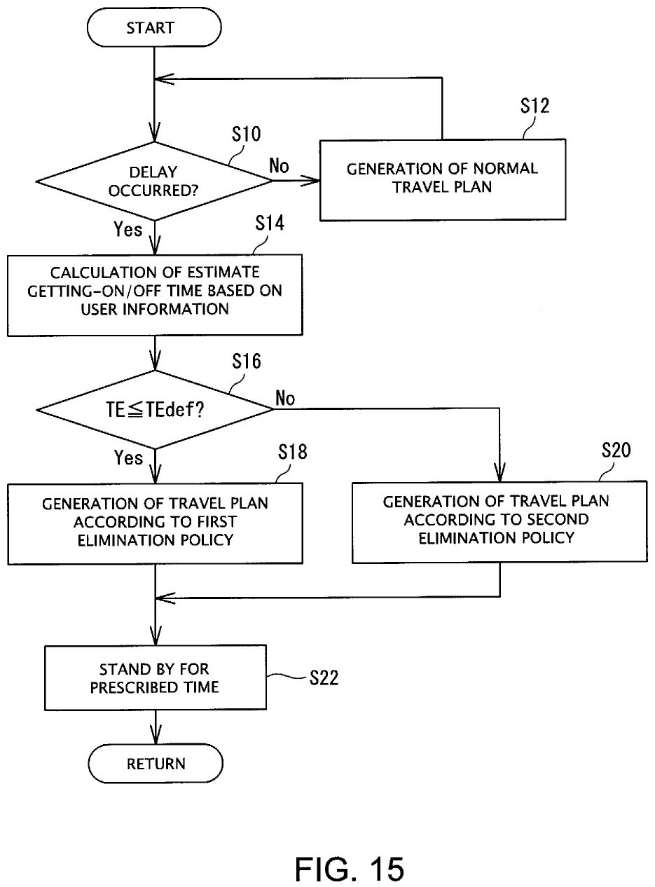

FIG. 15 is a flow chart showing a flow of the processing by the plan generation unit 14. The plan generation unit 14 monitors the occurrence or non-occurrence of a delay of not less than a fixed level (S10). In other words, the plan generation unit 14 periodically obtains the delay amounts DL of the respective vehicles 52 from the operation monitoring unit 18 and compares the delay amounts DL with the predetermined permissible delay amount DLmax. If the compared result shows that the delay amounts DL are less than the permissible delay amount DLmax (Yes in S10), the plan generation unit 14 judges that no delay has occurred, generates a normal travel plan 80, and transmits it (S12).

On the other hand, if the delay amount DL is a permissible delay amount DLdef or more (No in S10), the plan generation unit 14 calculates the estimated getting-on/off time TE of the maximum delayed vehicle 52 at the station 54 based on the user information (S14). The estimated getting-on/off time TE may be a getting-on/off time at the station where the maximum delayed vehicle 52 arrives in the closest future or may be an average value or a maximum value of the getting-on/off times at the plurality of stations 54. When the estimated getting-on/off time TE is calculated, the plan generation unit 14 compares the estimated getting-on/off time TE with a predetermined standard getting-on/off time TEdef (S16). The standard getting-on/off time TEdef is not limited to a particular value. For example, it may be a value equal to the scheduled stop time TSp predetermined as the standard stop time TS or a value smaller than the scheduled stop time TSp. When the compared result shows TE≤TEdef (Yes in S16), it can be judged that the delayed vehicle 52 can be considerably accelerated to a level higher than the standard schedule speed VS by decreasing the stop time TS. In this case, the plan generation unit 14 selects the first elimination policy and generates the travel plan 80 according to the first elimination policy (S18).

On the other hand, when TE>TEdef (No in S16), it is judged that the delayed vehicle 52 is hardly accelerated considerably to a level higher than the standard schedule speed VS*. In such a case, the plan generation unit 14 selects the second elimination policy and generates the travel plan 80 according to the second elimination policy (S20).

As described above, the second elimination policy includes the deceleration type elimination policy and the combination type elimination policy. The second elimination policy in step S20 may be the deceleration type elimination policy or the combination type elimination policy. Therefore, in step S20, the plan generation unit 14 may generate the travel plan 80 that temporarily decelerates the vehicles 52 other than the maximum delayed vehicle 52 or may generate the travel plan 80 that equalizes the delay amounts DL of all the vehicles 52. The step S20 may also include a step that the plan generation unit 14 selects one elimination policy from the deceleration type elimination policy and the combination type elimination policy based on the estimated getting-on/off time TE.

After generating the travel plan 80 according to the elimination policy, the plan generation unit 14 waits for a prescribed time (S22). It is because the delay of the vehicle 52 is actually eliminated only after the elapse of a prescribed time after the regenerated travel plan 80 is transmitted. After waiting for the prescribed time, the plan generation unit 14 returns to step S10 and repeats the processes of steps S10 to S22.

As is apparent from the above description, when the delay of not less than the prescribed time occurs in this case, the getting-on/off time at the station 54 is estimated based on the user information, the elimination policy is selected based on the estimated getting-on/off time TE, and the travel plan 80 is generated according to the selected elimination policy. Thus, when the delay occurs, the congestion and the like caused by the delay can be suppressed effectively by regenerating the travel plan 80 at an early stage. In addition, a more appropriate elimination policy can be selected by selecting the elimination policy according to the user information obtained in real time, and the interval error can be eliminated more surely while suppressing unnecessary prolongation of the waiting time and traveling time.

In the above description, the estimated getting-on/off time TE is calculated based on both the occupant information 84 and the waiting person information 86, but the estimated getting-on/off time TE may be calculated based on only one of them. Moreover, the estimated getting-on/off time TE may also be calculated considering different information in addition to at least one of the occupant information 84 and the waiting person information 86. For example, if reservation can be made for getting on the vehicle 52, the reservation status and the like may be used for calculation of the estimated getting-on/off time TE. Additionally, information such as a day of the week, a time, an event around a station, and the like may be used for calculation of the estimated getting-on/off time TE.

In the above description, the elimination policy is selected based on only the estimated getting-on/off time TE, but other elements may be taken into consideration to select the elimination policy. For example, the elimination policy may be selected in consideration of a transportation demand, a road surface condition and a congestion state of the traveling route 50, the delay amount DL, and the like in addition to the estimated getting-on/off time TE. In the transportation system 10 of this case, the number of vehicles 52 configuring the line of vehicles is determined according to a transportation demand. Therefore, the elimination policy may be selected in consideration of the number of vehicles 52 instead of the transportation demand.

### REFERENCE SIGNS LIST

10 transportation system, 12 operation management device, 14 plan generation unit, 16 communication apparatus, 18 operation monitoring unit, 20 storage device, 22 processor, 24 I/O device, 26 communication I/F, 50 traveling route, 52 vehicle, 54 station, 56 autonomous drive unit, 58 driving unit, 60 autonomous drive controller, 62 environment sensor, 64 in-vehicle sensor, 66 position sensor, 68 communication apparatus, 70 station terminal, 72 in-station sensor, 74 communication apparatus, 80 travel plan, 82 traveling information, 84 occupant information, 86 waiting person information.

1. A transportation system comprising:
a traveling route along which a plurality of stations are located;
a line of vehicles consisting of a plurality of vehicles that autonomously travel along the traveling route; and
an operation management device for managing the operation of the plurality of vehicles, wherein:
the operation management device comprises:
a plan generation unit for generating a travel plan for each of the plurality of vehicles, and
a communication apparatus which transmits the travel plan to the vehicles and receives user information, which is information about users of the transportation system, from at least either the vehicles or the stations, wherein:
the plan generation unit has at least two elimination policies for eliminating an interval error which is a difference between an operation interval of the vehicles and a predetermined target operation interval, and if the vehicles are delayed from the travel plan, selects one elimination policy from the at least two elimination policies based on at least the user information, and generates the travel plan according to the selected elimination policy.

2. The transportation system according to claim 1, wherein:
the plan generation unit estimates, based on the user information, a time required for getting on/off the vehicles at the stations as an estimated getting-on/off time and selects the elimination policy based on at least the estimated getting-on/off time.

3. The transportation system according to claim 2, wherein:
the plan generation unit, when the estimated getting-on/off time is not more than a prescribed standard getting-on/off time, selects a first elimination policy that eliminates the interval error without lowering the schedule speed of all the vehicles from the schedule speed before the delay occurs, and when the estimated getting-on/off time exceeds the standard getting-on/off time, selects a second elimination policy that eliminates the interval error by lowering the schedule speed of some vehicles from the schedule speed before the delay occurs.

4. The transportation system according to claim 1, wherein:
each of the vehicles has an in-vehicle sensor for obtaining occupant information from which at least the number of the occupants can be grasped, and transmits the occupant information to the operation management device, and
the user information includes the occupant information.

5. The transportation system according to claim 1, wherein:
each of the stations has an in-station sensor for obtaining waiting person information from which at least the number of the waiting persons can be grasped, and transmits the waiting person information to the operation management device, and
the user information includes the waiting person information.

6. The transportation system according to claim 4, wherein:
the user information is information from which attributes of users such as occupants or waiting persons can be grasped.

7. The transportation system according to claim 6, wherein:
the attributes include at least one among the use of a wheelchair, the use of a white cane, the use of an orthosis, the use of a baby carriage, and age groups.

8. An operation management device, comprising:
a plan generation unit for generating a travel plan for each of a plurality of vehicles that autonomously travel along a prescribed traveling route; and
a communication apparatus which transmits the travel plan to the vehicles and receives user information, which is information about users of the plurality of vehicles, from at least either the vehicles or the stations provided along the traveling route, wherein:
the plan generation unit has at least two elimination policies for eliminating an interval error which is a difference between an operation interval of the vehicles and a predetermined target operation interval, and if the vehicles are delayed from the travel plan, selects one elimination policy from the at least two elimination policies based on at least the user information, and generates the travel plan according to the selected elimination policy.

9. An operation management method, comprising:
receiving user information, which is information about users of a plurality of vehicles, from at least either the plurality of vehicles that autonomously travel along a prescribed traveling route and stations disposed along the traveling route; and
if the vehicles are delayed from a travel plan, selecting one elimination policy, based on at least the user information, from at least two elimination policies for eliminating an interval error which is a difference between an operation interval of the vehicles and a predetermined target operation interval, and regenerating the travel plan according to the selected elimination policy; and
transmitting the regenerated travel plan to the vehicles.
